(19) United States
(12) Patent Application Publication
(10) Pub. No.: US 2003/0066060 A1
(43) Pub. Date: Apr. 3, 2003

(54) Cross profile guided optimization of program execution

(76) Inventor: Richard L. Ford, Clinton, MA (US)

Correspondence Address: Blakely, Sokoloff, Taylor & Zafman, Seventh Floor, 12400 Wilshire Boulevard, Los Angeles, CA, 90025-1030, US

(21) Appl. No.: 09/966,412

(22) Filed: Sep. 28, 2001

(51) Int. Cl. G06F 9/45

(52) U.S. Cl. 717/158

(57) ABSTRACT

Methods and apparatus are disclosed for performing cross profile guided optimization of program execution. According to one embodiment, optimization of the execution of an application program is achieved by receiving the application program; compiling the application program into a first compiled version for execution by a first processor; executing the first compiled version using the first processor; capturing profile data during the execution of the first compiled version; and compiling the application program into a second compiled version for execution by a second processor, including optimization based at least in part on the captured profile data.

### COPYRIGHT NOTICE

Contained herein is material that is subject to copyright protection. The copyright owner has no objection to the facsimile reproduction by anyone of the patent document or the patent disclosure, as it appears in the United States Patent and Trademark Office patent file or records, but otherwise reserves all rights to the copyright whatsoever. The following notice applies to the software and data as described below and in the drawings hereto: Copyright© 2001, Intel Corporation, All Rights Reserved.

### FIELD OF THE INVENTION

This invention relates to computers in general, and more specifically to cross profile guided optimization of program execution.

### BACKGROUND OF THE INVENTION

There are various methods by which the execution of computer programs may be optimized to improve operation characteristics. Profile guided optimization (PGOPT) is an optimization method whereby a program compiler instruments a program such that, when the program is executed on a target system, execution and value profile information is captured and saved. The execution and value profile information can then be returned to the compiler to guide the optimization of the program. Profile guided optimization thus is a process in which efficiencies in a program can be discovered dynamically as the program is applied to typical runtime loads. Profile guided optimization is effective in, for example, code that includes branches that are frequently executed, resulting in outcomes that are relatively consistent but that are difficult to predict without executing the code.

Profile guided optimization may also be referred to as a two-pass optimization method in that the application program is compiled twice in order to obtain optimization of the operation of the program. In profile guided optimization, code is said to be “instrumented”, indicating that instructions have been included in the compiled software to monitor the operation of the application execution. Each time the instrumented code is executed, the compiler generates and stores profile information regarding the execution process. The compiler utilizes the captured profile information to produce an optimized program version.

An example of conventional profile guided optimization is shown in FIG. 1. In FIG. 1, the application program is received, process block 105, and the program is compiled into a first compiled version, process block 110, with the first compiled version being intended for the microprocessor that will ultimately execute the program. The first compiled version of the program is then executed using the microprocessor, process block 115. In the execution of the program, profile data is collected and stored, process block 120. The application is then compiled into a second compiled version, process block 125, including the optimization of the second compiled version using the collected profile data, process block 130. The microprocessor then executes the optimized version of the program, process block 135.

However, the conventional profile guided approach is not always feasible. For example, potential difficulties arise when using profile guided optimization in conjunction with an embedded processor. With an embedded processor, there may be no facility for getting profiling information back to the host machine or it may be slow or inefficient to do so. In such a case, it may be necessary to accomplish any optimization before executing the program, with optimization being based on the program itself. An example of such conventional static optimization is shown in FIG. 2. In the FIG. 2 example, the application program is received, process block 205, and the program is compiled into a compiled version, process block 210. Because in this example it is not feasible to capture and store profile information, the compiled program is instead optimized based on the received application program itself, process block 215, without the benefit of runtime data. The microprocessor then executes the optimized version of the program, process block 220. The optimization method shown in FIG. 2 may provide inadequate results because the optimization is not based on information obtained from actual program execution, but rather is based on the received program.

An alternative to other optimization methods involves the use of a simulator that can run the application program, capture profile information, and provide the profile information to the compiler. However, the use of a simulator also has disadvantages. The simulator will generally be much slower than the execution of code either on the target processor or on a host processor of a machine. Further, a conventional simulator requires the use of additional hardware and software outside of the system being operated, and thus the optimization is only possible when the simulator is available and coupled to the system. The use of a simulator may impose significant costs in convenience, operational time, and equipment.

### BRIEF DESCRIPTION OF THE DRAWINGS

The appended claims set forth the features of the invention with particularity. The invention, together with its advantages, may be best understood from the following detailed descriptions taken in conjunction with the accompanying drawings, of which:

FIG. 1 is a flow chart illustrating a conventional profile guided optimization method;

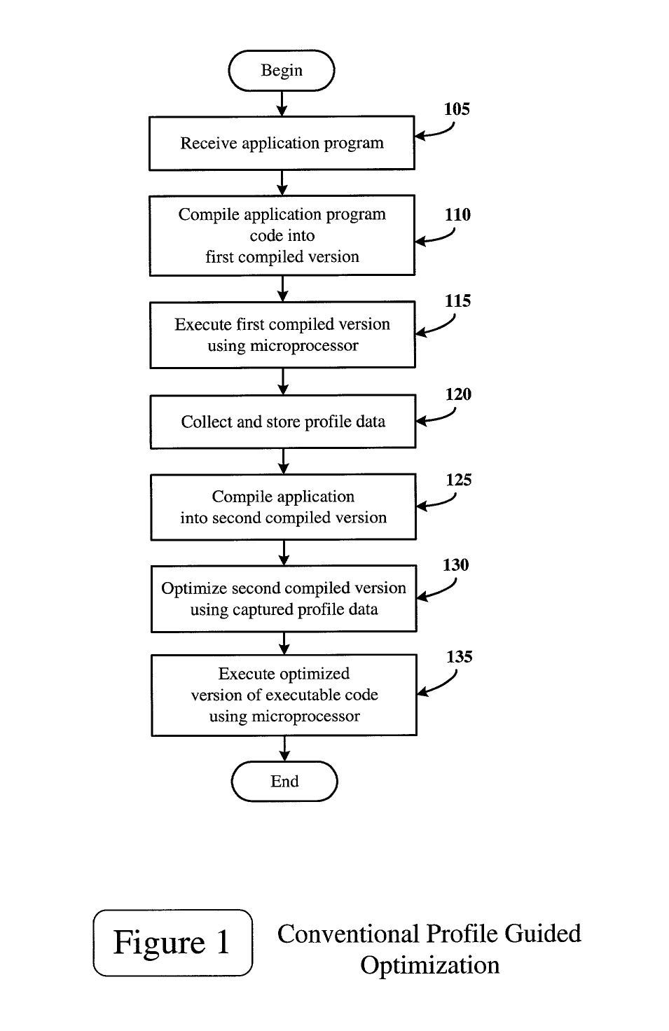

FIG. 2 is a flow chart illustrating a conventional optimization method without profile guided optimization;

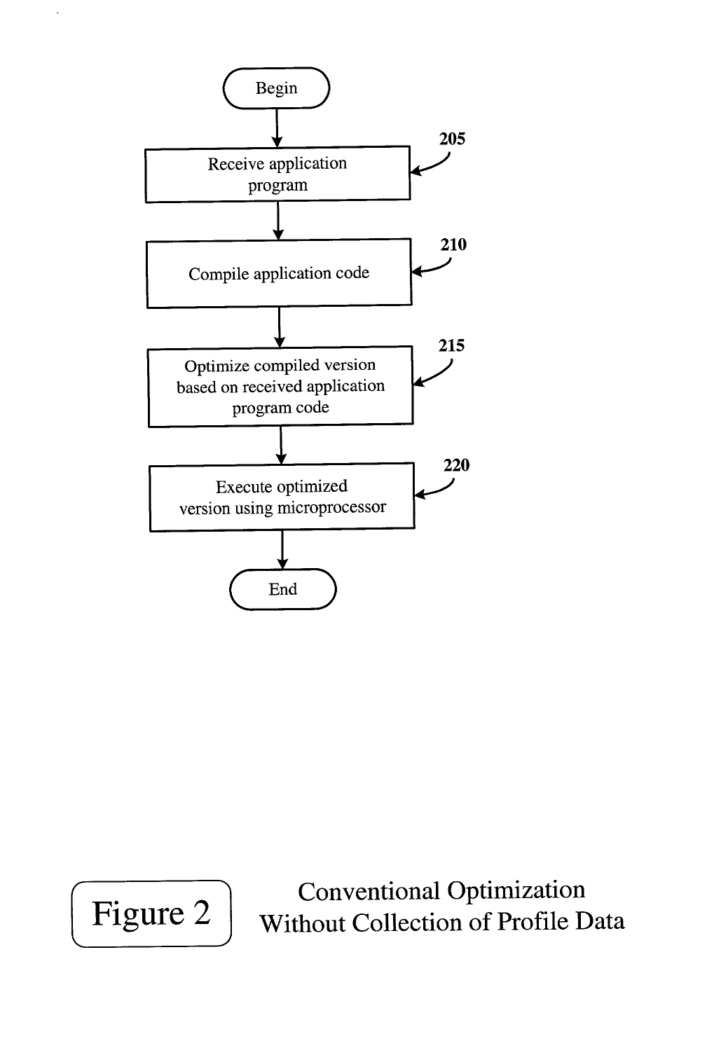

FIG. 3 is a flow chart illustrating an exemplary cross profile guided optimization method;

FIG. 4 demonstrates an exemplary cross profile optimizing system; and

FIG. 5 illustrates an exemplary device that is subject to cross profile guided optimization.

### DETAILED DESCRIPTION

A method and apparatus are described for cross profile guided optimization of program execution. Cross profile guided optimization may be utilized to optimize code intended for a target processor by compiling the code into a first compiled version, executing the first compiled version on another microprocessor, collecting profile information from the execution of the first compiled version, and compiling the code into a second compiled version that is optimized based at least in part on the collected profile information.

In the following description, for the purposes of explanation, numerous specific details are set forth in order to provide a thorough understanding of the present invention. However, it will be apparent to one skilled in the art that the present invention may be practiced without some of these specific details. In other instances, well-known structures and devices are shown in block diagram form.

The present invention includes various processes, which will be described below. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Terminology

Before describing an exemplary environment in which various embodiments of the present invention may be implemented, some terms that will be used throughout this application will briefly be defined:

As used herein, an “embedded processor” is generally a processor used in an embedded system, which is a specialized system including hardware and software that forms a component of some larger system and which is expected to function largely without intervention.

A “target processor” is a processor that an application program is intended for.

A “host processor” is a processor within a device that also includes a target processor, and includes a general purpose microprocessor.

“Cross profile guided optimization” generally refers to the process of optimizing an executable targeted to a first processor based at least in part upon profile information generated by the execution of instrumented executable on a second processor.

In an embodiment of cross profile guided optimization, an application program for a target processor in a system is directed to a first compiler to produce a first compiled version of the application program. The first compiled version is intended for a host processor in the system. The first compiled version is executed by the host processor and, during the execution of the first compiled version, profile information is captured and stored. The application program is then directed to a second compiler for the target processor. The profile information captured during the execution of the first compiled version is provided to the second compiler. The second compiler produces a second compiled version intended for the target processor that is optimized at least in part based upon the captured profile information.

While the embodiments described herein generally refer only to a first compilation and a second compilation, additional compilations and program executions are possible in different embodiments of cross profile guided optimization. In addition, the embodiments herein refer to a first compiler and a second compiler, but other compilation embodiments are possible. In some embodiments it may be possible for a single compiler to generate compilations for both the host processor and the target processor or for a single compiler driver to choose between different compiler components.

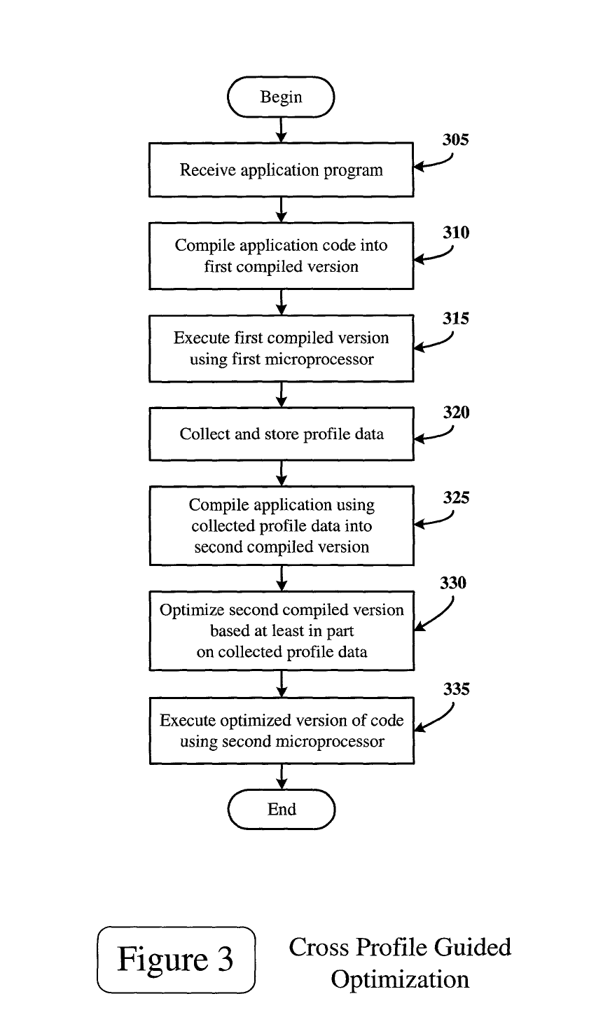

FIG. 3 illustrates an embodiment of a cross profile guided optimization method. In this embodiment, the application program is received, process block 305, and the program code is compiled into a first compiled version, process block 310, where the first compiled version is executable code intended for execution by a first microprocessor. The first microprocessor executes the first compiled version, process block 315, and profile data is collected and stored, process block 320. The application program is compiled in a second compiled version, process block 325, including the optimization of the executable code based at least in part on the captured profile data, process block 330. The optimized code is executed using a second processor, process block 335.

In a particular embodiment, the target processor in a system is an embedded processor. In an embodiment, the embedded processor may be unable to capture profile data or such operations may be impractical. The embedded processor may have limited file system capability for storing any data that is captured, or may not be capable of producing external communications. For this reasons, the embedded processor may be not capable of utilizing conventional profile guided optimization methods, and thus operations may be especially benefited by cross profile guided optimization. In a particular embodiment, a target processor is a processor based on the XScale microarchitecture of Intel Corporation of Santa Clara, Calif.

Note that while the limitations on functionality of certain embedded processors demonstrate the advantages and novelty of cross profile guided optimization, embodiments are not limited to such embedded processors, and embodiments may be also be utilized with processors possessing greater capabilities. Under certain embodiments, cross profile guided optimization may be implemented with a first processor and a second processor having different operating characteristics or capabilities or being provided with different resources that affect communications, storage, or other operating factors.

In an embodiment, a system subject to optimization includes a host processor that has the capability of executing a compiled version of a program that is intended for a target embedded processor. In addition, the host processor has the capability of collecting and storing profile data that may be used in optimizing a second compiled version of the program that is executed by the embedded processor.

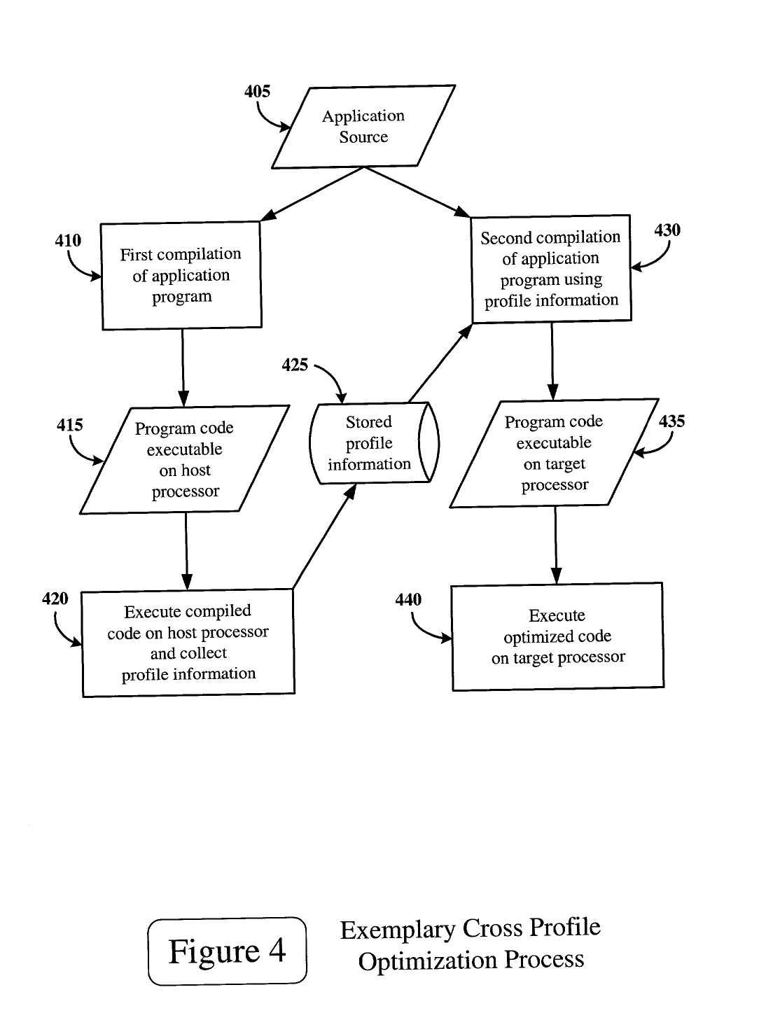

FIG. 4 is an illustration of an exemplary cross profile optimization process. An application program 405 intended for a target processor is made available to generate a first compilation 410 and a second compilation 430. The first compilation produces program code executable on the host processor 415. The application is executed on the host processor, with profile information being captured during execution 420, and the profile information is stored 425. The stored profile information 425 and the application source 405 are used in the second compilation 430. The result is program code that is executable on the target processor 435 and that has been optimized based at least in part on the captured profile information. The optimized application is then executed on the target processor 440.

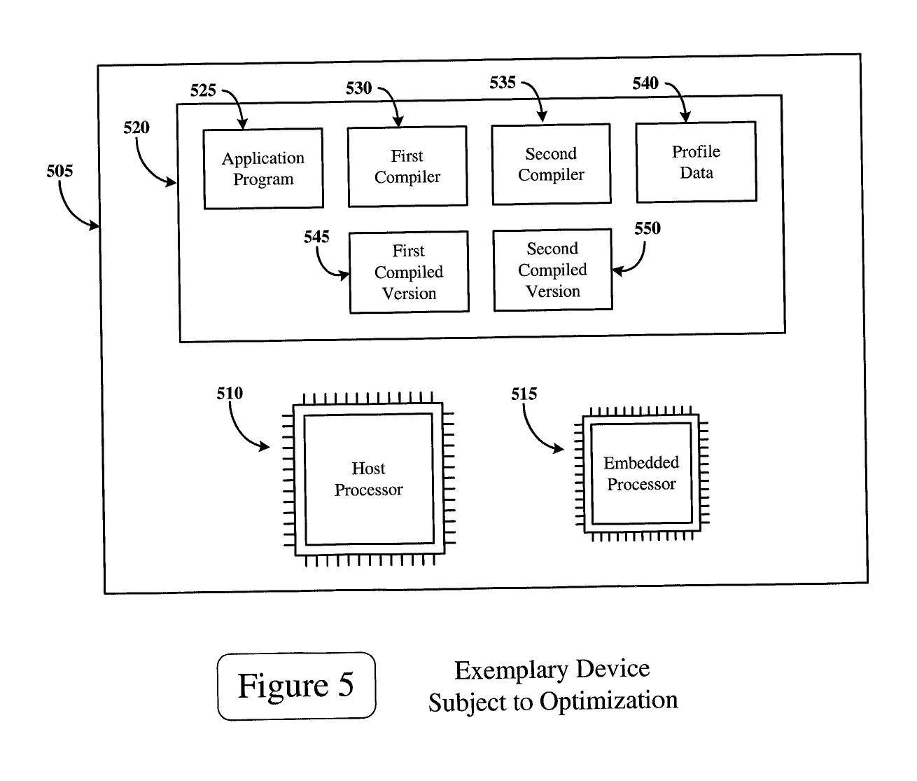

FIG. 5 illustrates an exemplary device that may be subject to optimization using an embodiment of cross profile guided optimization. The device 505 includes a host processor 510 and an embedded processor 515. The device also includes a memory 520. The memory 520 for device 505 is shown as a single unit within device 505 for the purposes of the illustration, but this is not necessary and the structure and location of the memory may vary in different embodiments. Memory 520 may include a variety of programs and other data. Included within the data stored in memory 520 may be an application program 525 that is intended for execution by embedded processor 515. Also stored in memory is a first compiler 530 to compile application program 525 for host processor 510. First compiler 530 compiles application program 525 into a first compiled version 545 for execution on host processor 510. During the execution of first compiled version 545, profile data 540 is captured and is stored in memory 520. In certain embodiments profile data 540 may be stored in a memory cache. Second compiler 535 compiles application program 525 using the captured profile data 540 to generate a second compiled version 550 for the embedded processor 515 that has been optimized based at least in part upon the captured profile data 540. The embedded processor 515 can then execute the optimized second compiled version 550.

In certain embodiments, device 505 may be a computer system. For illustration purposes, FIG. 5 does not include all components and couplings of a device that may be subject to cross profile guided optimization. Excluded details include input and output interfaces, display devices, data input devices, additional memory devices, data buses, power sources, and other commonly used components, subassemblies, and devices necessary for operation of a computer system.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method comprising:
receiving an application program;
compiling the application program into a first compiled version for execution by a first processor;
executing the first compiled version using the first processor;
capturing profile data during the execution of the first compiled version; and
compiling the application program into a second compiled version for execution by a second processor, the compiling of the second compiled version including optimization based at least in part on the captured profile data.

2. The method of claim 1, further comprising storing the profile data in a memory.

3. The method of claim 1, further comprising executing the second compiled version using the second processor.

4. The method of claim 1, wherein the first compiled version is instrumented with monitoring instructions to direct the capture of profile data.

5. The method of claim 1, wherein the second processor is an embedded processor.

6. The method of claim 5, wherein the second processor is not capable of capturing profile data.

7. The method of claim 5, wherein the second processor is not capable of generating external communications.

8. The method of claim 1, wherein the first processor is a host processor for a device and wherein the device includes the second processor.

9. The method of claim 1, wherein compiling the application program into a first compiled version utilizes a first compiler and wherein compiling the application program into a second compiled version utilizes a second compiler.

10. The method of claim 1, wherein compiling the application program into a first compiled version and compiling the application program into a second compiled version are performed with a single compiler.

11. A machine-readable medium having stored thereon data representing instructions that, when executed by a processor, cause the processor to perform operations comprising:
receiving an application program;
compiling the application program into a first compiled version for execution by a first processor;
executing the first compiled version using the first processor;
capturing profile data during the execution of the first compiled version; and
compiling the application program into a second compiled version for execution by a second processor, the compiling of the second compiled version including optimization based at least in part on the captured profile data.

12. The medium of claim 11, wherein the instructions include instructions that, when executed by a processor, cause the processor to perform operations comprising storing the profile data in a memory.

13. The medium of claim 11, wherein the instructions include instructions that, when executed by a processor, cause the processor to perform operations comprising executing the second compiled version using the second processor.

14. The medium of claim 11, wherein the first compiled version is instrumented with monitoring instructions to direct the capture of profile data.

15. The medium of claim 11, wherein the second processor is an embedded processor.

16. The medium of claim 15, wherein the second processor is not capable of capturing profile data.

17. The medium of claim 15, wherein the second processor is not capable of generating external communications.

18. The medium of claim 11, wherein the first processor is a host processor for a device and wherein the device includes the second processor.

19. The medium of claim 11, wherein compiling the application program into a first compiled version utilizes a first compiler and wherein compiling the application program into a second compiled version utilizes a second compiler.

20. The medium of claim 11, wherein compiling the application program into a first compiled version and compiling the application program into a second compiled version are performed with a single compiler.

21. A system comprising:
one or more memories, data being stored within the one or memories including a first compiler and a second compiler, the first compiler compiling an application program into a first compiled version;
a host microprocessor, the host microprocessor executing the first compiled version, the host microprocessor capturing profile data during the execution of the first compiled version; and
a target processor, the second compiler compiling the application code into a second compiled version for execution by the target processor, the second compiled version being optimized based at least in part on the captured profile data.

22. The system of claim 21, wherein the captured profile data is stored in the one or more memories.

23. The system of claim 21, wherein the target microprocessor is an embedded microprocessor.

24. The system of claim 23, wherein the target microprocessor does not have the capability of capturing a profile data.

25. The system of claim 23, wherein the target microprocessor does not have the capability of generating external communications.

26. A method of optimizing the execution of a program by an embedded processor comprising:
obtaining the program;
compiling the program to generate a first set of compiled code, the first set of compiled code being instrumented to monitor the execution of the first set of compiled code;
executing the first set of compiled code on a host processor, the host processor being contained in a device that also contains the embedded processor;
capturing profile information during the execution of the first set of compiled code and saving the profile information in a memory;
compiling the program to generate a second set of compiled code, the second set of compiled code being optimized based at least in part on the captured profile information; and
executing the second set of compiled code using the embedded processor.

27. The method of claim 26, wherein the first set of compiled code is compiled utilizing a first compiler and the second set of compiled code is compiled utilizing a second compiler.

28. The method of claim 26, wherein the first set of compiled code and the second set of compiled code are compiled utilizing a single compiler.
